(19) United States
(12) Patent Application Publication
(10) Pub. No.: US 2004/0139865 A1
(43) Pub. Date: Jul. 22, 2004

(54) JUICE EXTRACTOR

(76) Inventor: Chung Lun Yip, Kwun Tong (HK)

Correspondence Address: Ladas & Parry, 26 West 61 Street, New York, NY, 10023, US

(21) Appl. No.: 10/723,459

(22) Filed: Nov. 26, 2003

(30) Foreign Application Priority Data
Dec. 17, 2002 (CN) 02250404.4

(51) Int. Cl. A23N 1/00

(52) U.S. Cl. 99/506; 99/501

(57) ABSTRACT

A juice extractor includes a vessel having an internally threaded sidewall, a juice-extracting dome positioned within the vessel, a plunger attached threadedly to the vessel sidewall for pressing fruit against the dome when a plunger is rotated, and a spout extending from the vessel through which juice extract from the fruit can pass to an external receptacle. A handle can be attached to the plunger to assist in rotating the plunger.

### BACKGROUND OF THE INVENTION

The present invention relates to juice extractors. More particularly, although not exclusively, the invention relates to a hand-powered fruit juice extractor for kitchen bench-top mounting.

The standard method of extracting juice from fruit is to cut the fruit into one or more pieces and squeeze the skin of the fruit upon the flesh of the fruit—allowing juice to fall therefrom into a receptacle. Many machines have been developed over the years to reduce the physical squeezing effort required. Some devices have fixed serrated domes against which a user must manually press the flesh of a fruit half, whilst pivotally oscillating the fruit half back and forth. Others have electrically driven rotating serrated domes against which the flesh of a fruit half is pressed. The former type of juice extractor can be difficult for the elderly or people having injured or arthritic hands for example. The latter on the other hand are expensive to manufacture—requiring powerful electric motors, switching, power cords and the like and require significant bench space and a conveniently located power outlet.

### Objects of the Invention

It is an object of the present invention to overcome or substantially ameliorate at least one of the above disadvantages and/or more generally to provide improved juice extractor.

### Disclosure of the Invention

There is disclosed herein a juice extractor comprising:

a vessel having an internally threaded sidewall,

a juice-extracting dome positioned within the vessel,

a plunger attached threadedly to the vessel sidewall for pressing fruit against the dome when a plunger is rotated, and

a spout extending from the vessel through which juice extract from the fruit can pass to an external receptacle.

Preferably the dome has an annular flange formed integrally therewith and having a plurality of apertures through which juice can pass en route to the spout.

Preferably the dome is serrated.

Preferably the juice extractor further comprises a base to which the vessel is attached, the base comprising a suction cup by which th juice extractor can be fixed to a bench top.

Preferably the juice extractor further comprises a spindle mounted rotatably to the base and attached threadedly to the suction cup and adapted upon rotation to draw a central portion of the suction cup upwardly and away from the bench top to induce a vacuum between the suction cup and the bench top.

Preferably the vessel is a bayonet-secured to the base.

Preferably the base further comprises a key-way into which a key is received to prevent rotation of the vessel with respect to the base.

There is further disclosed herein a combination of the above-disclosed juice extractor and a handle attached to and extending radially from the plunger to assist in rotating the plunger.

Preferably the plunger has a splined exterior and the handle comprises a ring having a splined interior that mates with the splined exterior of the plunger.

There is further disclosed herein a combination of the above-disclosed juice extractor and a handle attached to and extending radially from the spindle to assist in rotating the spindle.

### BRIEF DESCRIPTION OF THE DRAWINGS

A preferred form of the present invention will now be described by way of example with reference to the accompanying drawings, wherein:

FIG. 1 is a schematic parts-exploded perspective illustration of a juice extractor and handle,

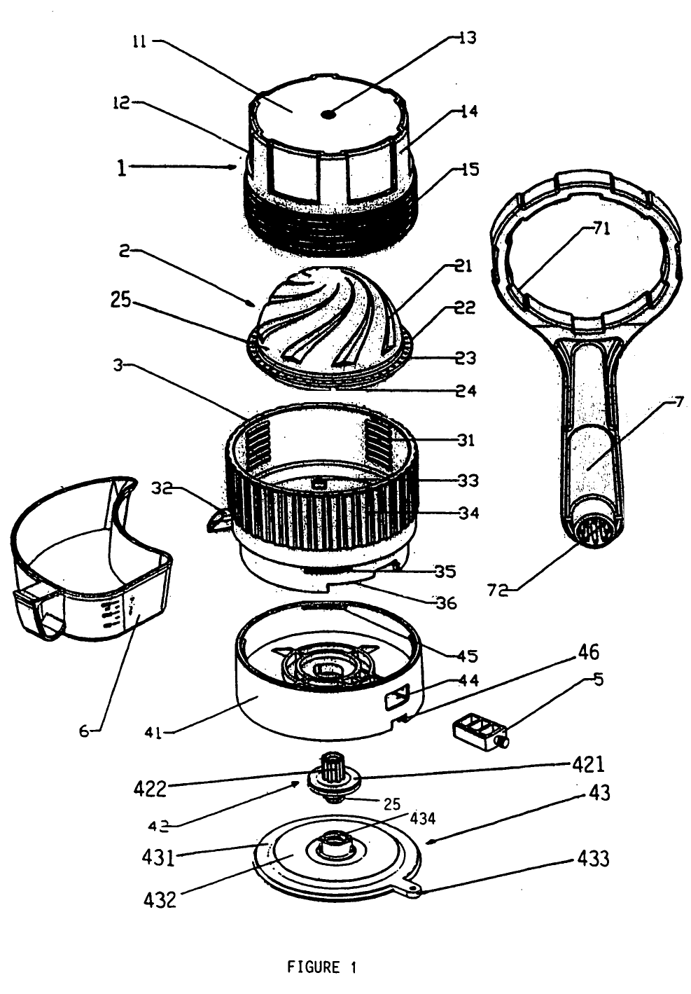

FIG. 2 is a schematic diagram of the assembled juice extractor with handle attached,

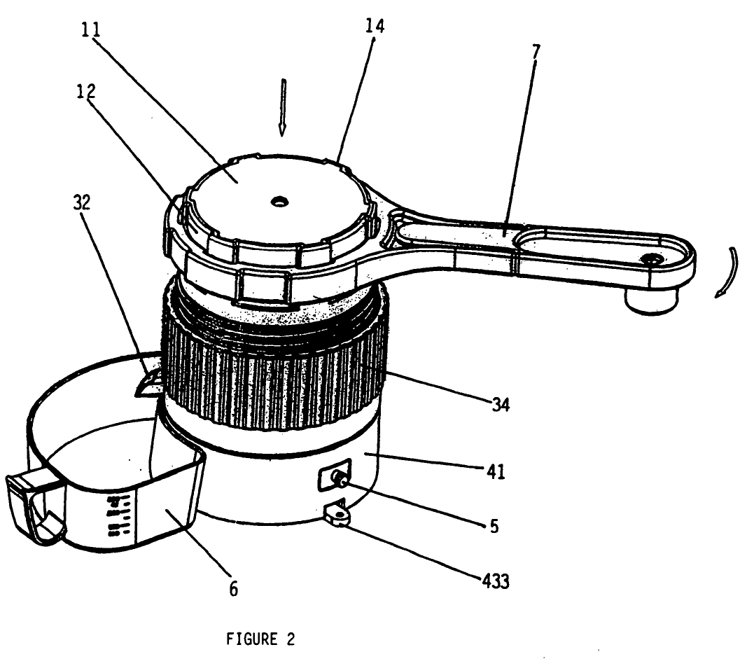

FIG. 3 is a schematic perspective illustration of the base of the juice extractor having a handle attached thereto,

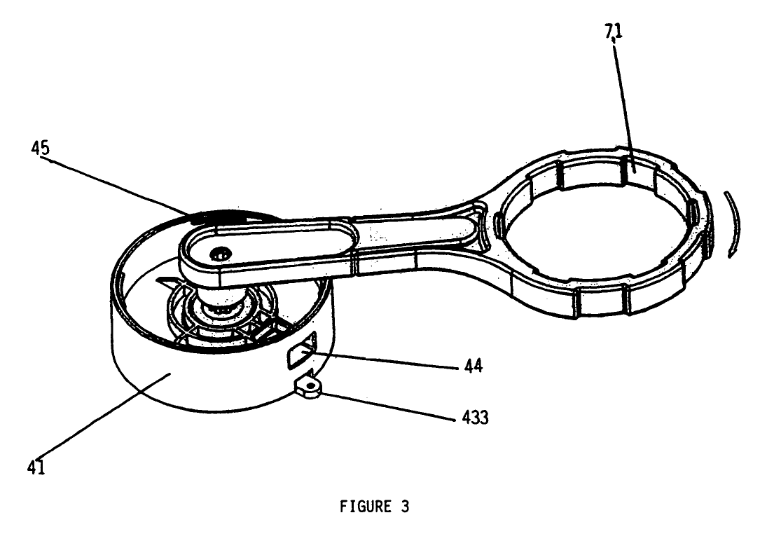

FIG. 4 is a schematic perspective illustration of the handle, and

FIG. 5 is a schematic parts-exploded perspective illustration of the handle.

### DESCRIPTION OF THE PREFERRED EMBODIMENT

In the accompanying drawings there is depicted schematically a juice extractor formed of moulded plastics material and comprising a vessel 3 having a substantially cylindrical shape with a sidewall 34 having internal thread 31. Th re is a locking tab 33 in the base of the vessel 3. There is a spout 32 extending from the vessel and via which juice can pass en route to an external receptacle 6. At the bottom of the vessel 3 there is a set of bayonet lugs 35 and a cut-out 36. The vessel 3 can be bayonet-mounted to a base 41 which comprises bayonet lugs 45 under which the lugs 35 of the vessel can be received upon insertion and turning of the vessel 3. There is a key-way 44 into which a key 5 can be inserted after the vessel 3 is installed upon the base to prevent rotation of the vessel in use. The key 5 co-operate with the cut-out 36 of the vessel 3.

Attached to the base 41 by a spindle 42 is a suction cup 43. The spindle 42 has an upwardly extending spline 422 and a downwardly depending thread 25. Thread 25 engages with thread 434 at the top of the centre 432 of the suction cup 43. The suction cup 43 has a periphery 431 from which a lifting tab 433 extends.

Within the vessel 3 there is provided a dome 2 having serrations 21 and a peripheral flange 22 having apertures 23 therethrough. There is a skirt depending from the dome having a cut-out 24 that co-operate with the locking tab 33 in the vessel 3 to prevent rotation of the dome 2 within the vessel 3.

There is a plunger 1 having external thread 15 by which the plunger is screwed down upon and within the vessel 3. Thread 15 co-operates with thread 31 of the vessel 3. The plunger has a sidewall 12.with vertical splines 14. There is a lid attached by screw 13 to the plunger.

There is a handle 7 with a large open ring 73 having internal slots 71 to fit over the plunger 1 and co-operate with the splines 14.

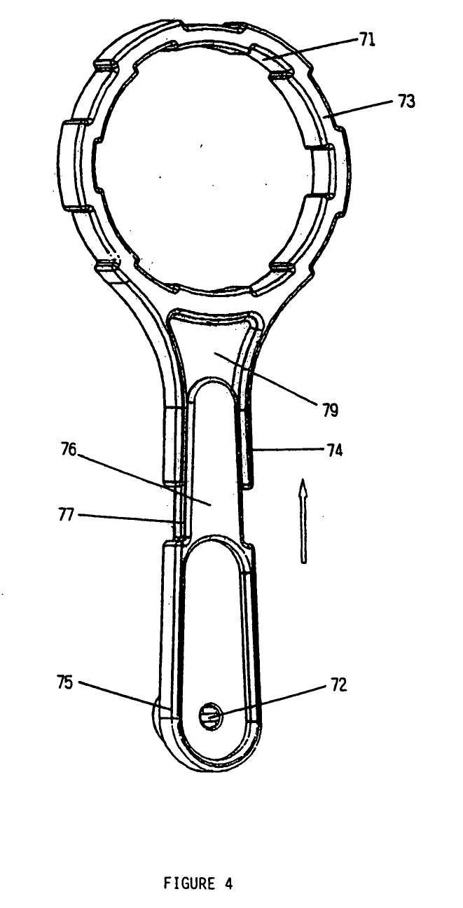

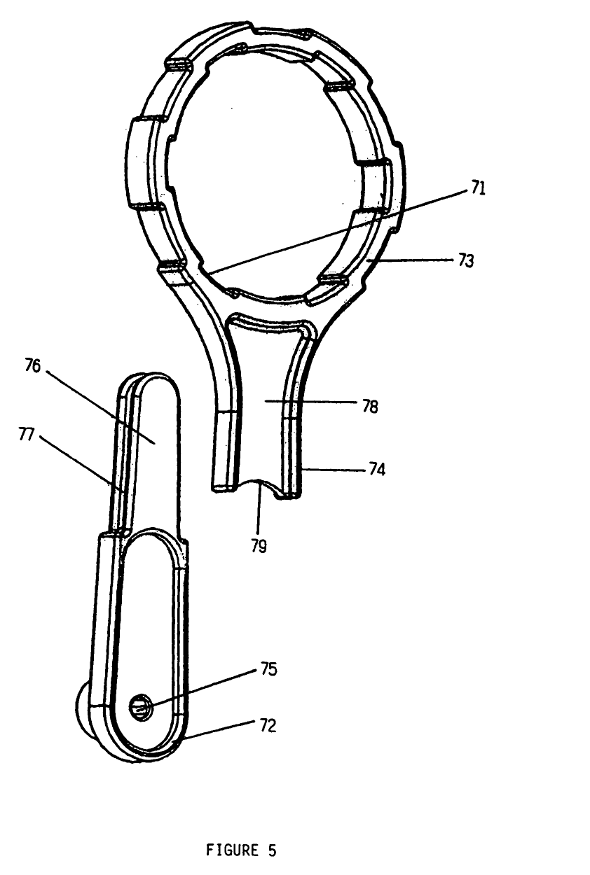

The handle as better illustrated in FIGS. 4 and 5 has two parts that can detach from one another. To this end, there is a pair of tongues 76 and 77 that slide against either side of a plate 79 flanked by guide rails 74. There is a tight fit between the tongues 76, 77 and the plate 79.

At the smaller end 75 of the handle there is a splined aperture 72 that can be fitted upon the spline 422 of the spindle 42 to assist in securing the base 41 to a bench top.

In use, one places the base 41 upon a bench top and attaches the spline 72 of the handle 7 to the spline 422 of the spindle 42 and turns the handle to fix the base to th bench top by inducing a vacuum under the suction cup as it is drawn upwardly at its centre. The vessel 3 is then placed down upon and turned to thereby bayon t-engage with the base. The key 15 is then inserted to prevent reverse rotation. The dome 2 is then placed in the vessel 3 in such manner that the cut-out 42 interlocks with the locking tab 33. One can then place a piece of cup fruit—typically citrus fruit flesh-side-down upon the dome 2. The plunger 1 can then be threaded upon the vessel 3 to press the fruit against the dome 2. If additional turning force is required, the ring 73 of the handle can be fitted around the sidewall 12 such that slots 71 receive the splines 14 the handle can then be turned. The juice is received in the receptacle 6 via spout 32 for transfer to a drinking vessel.

It should be appreciated that modifications and alterations obvious to those skilled in the art are not to be considered as beyond the scope of the present invention. For example, the vessel 3 might be formed integrally with the base 41.

1. A juice extractor comprising:
a vessel having an internally threaded sidewall,
a juice-extracting dome positioned within the vessel,
a plunger attached threadedly to the vessel sidewall for pressing fruit against the dome when a plunger is rotated, and
a spout extending from the vessel through which juice extract from the fruit can pass to an external receptacle.

2. The juice extractor of claim 1 wherein the dome has an annular flange formed integrally therewith and having a plurality of apertures through which juice can pass en route to the spout.

3. The juice extractor of claim 1 wherein the dome is serrated.

4. The juice extractor of claim 1 further comprising a base to which the vessel is attached, the base comprising a suction cup by which the juice extractor can be fixed to a bench top.

5. The juice extractor of claim 4 further comprising a spindle mounted rotatably to the base and attached threadedly to the suction cup and adapted upon rotation to draw a central portion of the suction cup upwardly and away from the bench top to induce a vacuum between the suction cup and the bench top.

6. The juice extractor of claim 4 wherein the vessel is a bayonet-secured to the base.

7. The juice extractor of claim 6 comprising a key-way into which a key is received to prevent rotation of the vessel with respect to the base.

8. In combination with the juice extractor of claim 1, a handle attached to and extending radially from the plunger to assist in rotating the plunger.

9. The combination of claim 8 wherein the plunger has a splined exterior and the handle comprises a ring having a splined interior that mates with the splined exterior of the plunger.

10. In combination with the juice extractor of claim 5 a handle attached to and extending radially from the spindle to assist in rotating the spindle.
